(19) United States
(12) Patent Application Publication
(10) Pub. No.: US 2016/0147005 A1
(43) Pub. Date: May 26, 2016

(54) Lighting Device and Liquid Crystal Display Apparatus

(71) Applicant: SAKAI DISPLAY PRODUCTS CORPORATION, Osaka (JP)

(72) Inventor: Tomoo Sasaki, Sakai-shi, Osaka (JP)

(21) Appl. No.: 14/900,352

(22) PCT Filed: Jul. 11, 2014
(86) PCT No.: PCT/JP2014/068625

§ 371 Date: Dec. 21, 2015

(30) Foreign Application Priority Data
Jul. 26, 2013 (JP) 2013-156029

(51) Int. Cl. F21V 8/00

(52) U.S. Cl. CPC G02B 6/0031; G02B 6/0068; G02B 6/0085; G02B 6/0091

(57) ABSTRACT

Provided is a lighting device and a liquid crystal display apparatus that can reduce a loss of light.

A lighting device 40 reflecting light from a light source 61, making reflected light enter one side surface of a light guide plate 80, and outputting entered light from one surface of the light guide plate 80. The reflection part 96 reflecting light at an inner surface and having, at an inside of the reflection part 96, a hollow part extending in a long side direction of one side surface of the light guide plate 80, a cross section of the hollow part perpendicular to the long side direction of the one side surface having a circular shape, and a plurality of light sources 61 arranged in the long side direction of the one side surface along an outer side surface of the reflection part 96, wherein the reflection part 96 includes a first opening 94 through which light enters inside from the plurality of light sources 61, and a second opening 95 for outputting light entered from the first opening 94 and reflected at an inner surface to the one side surface of the light guide plate 80, the lighting device further comprising a light shielding part 93 shielding light output from the second opening 95 and leaking to an outside of the one side surface of the light guide plate 80.

### CROSS-REFERENCE TO RELATED APPLICATIONS

This application is the national phase under 35 U.S.C. §371 of PCT International Application No. PCT/JP2014/068625 which has an International filing date of Jul. 11, 2014 and designated the United States of America.

### FIELD

The present application relates to a lighting device and a liquid crystal display apparatus.

### BACKGROUND

A lighting device (backlight) has been provided which reflects light from a light source and outputs the reflected light from one surface of a light guide plate included in a liquid crystal display apparatus (see Japanese Patent Application Laid Open No. 2013-48094, for example). In the lighting device according to Japanese Patent Application Laid Open No. 2013-48094, a light source is mounted on a substrate arranged in parallel with one surface of the light guide plate. The lighting device according to Japanese Patent Application Laid Open No. 2013-48094 reflects light output from a light source at a curved inner side surface of a partially tubular portion in order to uniformize the light from the light source, and make the reflected light enter one side surface of a light guide plate. The lighting device outputs the entered light from one surface of the light guide plate to a liquid crystal panel.

### SUMMARY

In the lighting device according to Japanese Patent Application Laid Open No. 2013-48094, however, a large part of the light output from the light source to the opposite side of the light guide plate is reflected at the inner side surface of the partially tubular portion and is returned to the light source. Thus, a part of the light from the light source is not utilized for displaying an image, resulting in a loss of light.

The present invention has been made in view of the circumstances described above. An object of the invention is to provide a lighting device and a liquid crystal display apparatus that can reduce a loss of light.

The lighting device according to the present invention is characterized by a lighting device, comprising , a reflection part with a circular cross section which is perpendicular to a long side direction of one first side surface of a light guide plate outputting light entered the one side surface from one surface, having a hollow part extending in the long side direction of the one side surface, and further including a first opening for making light enter an inside of the hollow part, a second opening for outputting light entered from the first opening and reflected at an inner surface to the one side surface of the light guide plate, and a light shielding part shielding light output from the second opening and leaking to an outside of the one side surface of the light guide plate; and a plurality of light sources arranged in the long side direction of the one side surface along an outer side surface of the reflection part and making emitted light enter from the first opening.

The lighting device according to the present invention is characterized in that a curved surface curved inward is formed at an inner surface portion of the reflection part facing the first opening.

The lighting device according to the present invention is characterized in that the plurality of light sources are arranged in a plurality of rows along an outer side surface of the reflection part, and the reflection part includes a plurality of the first openings for making light enter from each row of the light source.

The lighting device according to the present invention is characterized by including: a substrate on which the light source is mounted on one surface; a reflection sheet with one surface covering another surface of the light guide plate; and a heat dissipation plate being in contact with another surface of the reflection sheet and being wider than the reflection sheet, wherein another surface of the substrate is in contact with the heat dissipation plate.

The liquid crystal display apparatus to the present invention is characterized by a liquid crystal display apparatus including the lighting device according to the description above and a liquid crystal panel displaying an image using light output from one surface of the light guide plate in the lighting device.

The lighting device and liquid crystal display apparatus according to the present application may reduce a loss of light.

### BRIEF DESCRIPTION OF SEVERAL VIEWS OF DRAWINGS

FIG. 1 is a perspective view of a liquid crystal panel module seen from the front side.

FIG. 2 is an exploded perspective view of the backlight.

FIG. 3 illustrates the internal structure of the lower end of the backlight.

FIG. 4 is explanatory views for illustrating the procedure of assembling the backlight.

FIG. 5 is explanatory views for illustrating the procedure of assembling the backlight.

FIG. 6 is explanatory views for illustrating the procedure of assembling the backlight.

FIG. 7 is explanatory views for illustrating the procedure of assembling the backlight.

FIG. 8 is explanatory views for illustrating the procedure of assembling the backlight.

FIG. 9 is explanatory views for illustrating the procedure of assembling the backlight.

FIG. 10 is a view for illustrating a path of light output from the reflection member to the light guide plate.

FIG. 11 is a view for illustrating a path of light flux output from the reflection member to the light guide plate.

FIG. 12 is a view for illustrating the internal structure of the lower end of the backlight.

FIG. 13 is a section view illustrating the internal structure of the lower end of the backlight.

### DETAILED DESCRIPTION

A liquid crystal display apparatus according to an embodiment of the present application includes a display utilized for a television receiver, an electronic blackboard, a monitor used through connection with a tuner, a monitor used through connection with a desktop computer and a digital signage. Moreover, a liquid crystal display apparatus according to an embodiment of the present application includes a display utilized for a tablet computer, a personal digital assistant (PDA) and a mobile phone.

A liquid crystal panel module including a liquid crystal panel and a backlight (lighting device) will be described below as an example of a liquid crystal display apparatus with reference to the drawings illustrating the embodiments thereof.

### Embodiment 1

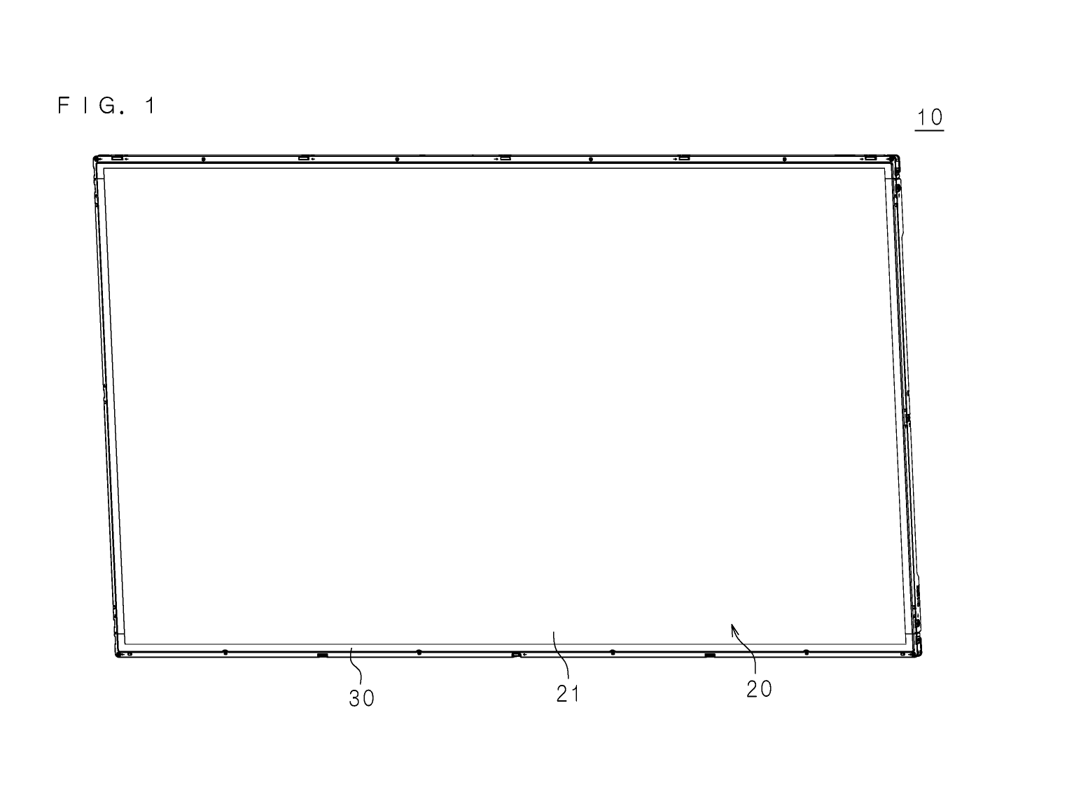

FIG. 1 is a perspective view of a liquid crystal panel module 10 seen from the front side. Here, if a viewer faces a screen 21 on which the liquid crystal panel module 10 in a standing posture displays an image, the side of the viewer on the screen 21 is regarded as a front side or a front surface side whereas the opposite side thereof is regarded as a rear side or a back surface side. The liquid crystal panel module 10 and the screen 21 each forms a horizontally long rectangular shape. When the viewer faces the screen 21, the right side in the long side direction of the screen 21 is regarded as a right side of the liquid crystal panel module 10 whereas the left side in the long side direction of the screen 21 is regarded as a left side of the liquid crystal panel module 10. The upper side in the short side direction of the screen 21 is regarded as an upper side of the liquid crystal panel module 10 whereas the lower side in the short side direction of the screen 21 is regarded as a lower side of the liquid crystal panel module 10.

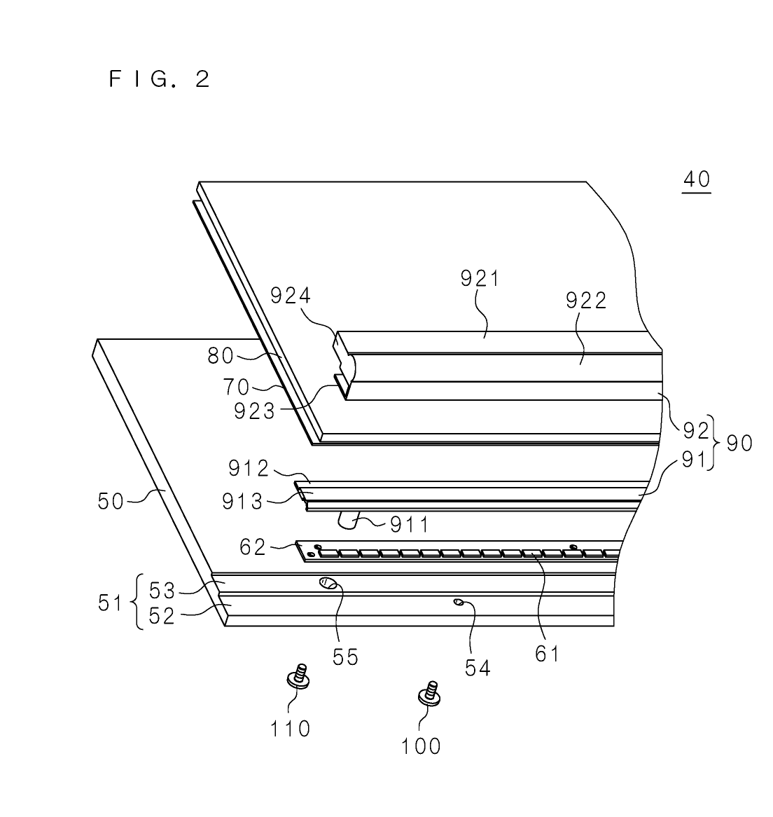

The liquid crystal panel module 10 includes a liquid crystal panel 20, a frame 30 and a backlight 40 (see FIG. 2).

The liquid crystal panel 20 has the screen 21 on the front side and displays an image on the screen 21. The backlight 40 employs an edge light system in which light emitting diodes (LEDs) are used as a light source.

The frame 30 is formed by combining a bar-like upper rim, two side rims and a lower rim so as to have a rectangular frame shape in the front view. The frame 30 covers the circumferences of the liquid crystal panel 20 and the backlight 40.

Between the frame 30 and the liquid crystal panel 20 as well as the backlight 40, a rectangular frame-shaped holder (not illustrated) made of synthetic resin is located. The holder serves to fix the liquid crystal panel 20 and the backlight 40.

Moreover, between the frame 30 and the backlight 40, a source substrate (not illustrated) which transmits on/off signals to LEDs is located.

FIG. 2 is an exploded perspective view of the backlight 40. FIG. 2 illustrates, from the lower left on the front side, components in a portion of the backlight 40 which constitutes a part around the lower left corner of the liquid crystal panel module 10 illustrated in FIG. 1. The backlight 40 includes a heat dissipation plate 50, LEDs 61, an LED substrate 62, a reflection sheet 70, a light guide plate 80 and a reflection member 90. The LEDs 61, LED substrate 62 and reflection member 90 constitute a light source module which emits light to a light guide plate 80. The backlight 40 may further include a backlight chassis located at the rear side of the heat dissipation plate 50, or alternatively, the heat dissipation plate 50 may also serve as a backlight chassis.

The heat dissipation plate 50 is a rectangular plate-like member made of, for example, iron or aluminum. The heat dissipation plate 50 has a function of discharging heat generated from the LED 61 to the outside of the liquid crystal panel module 10. At the lower end on the front face of the heat dissipation plate 50, a shelf part 51 having two steps in the front-back direction is located. The shelf part 51 includes a lower shelf 52 and an upper shelf 53. The lower shelf 52 and upper shelf 53 when viewed from the front side forms a long and narrow terrace shape extending in the long side direction of the heat dissipation plate 50.

At the lower shelf 52 and upper shelf 53 of the heat dissipation plate 50, a screw hole 54 and a through hole 55 are formed, respectively. In FIG. 2, one screw hole 54 and one through hole 55 are illustrated. However, multiple screw holes 54 and through holes 55 are formed in the extending direction of the lower shelf 52 and upper shelf 53, respectively. The screw holes 54 and through holes 55 are arranged in a staggered manner.

The LEDs 61 are provided in a multiple number.

The LED substrate 62 is a rectangular aluminum plate extending in the long side direction of the heat dissipation plate 50.

The multiple LEDs 61 are mounted on the front face of the LED substrate 62. The length of the LED substrate 62 is somewhat shorter than the long side of the heat dissipation plate 50. The width of the LED substrate 62 is substantially the same as the width of the lower shelf 52 of the heat dissipation plate 50. The rear face of the LED substrate 62 is adhered to the lower shelf 52 of the heat dissipation plate 50 with, for example, a double-sided tape.

The reflection sheet 70 is a film made of highly-reflective synthetic resin having a substantially rectangular shape corresponding to the rear face of the light guide plate 80. In order to effectively utilize the light output from the light guide plate 80 to the rear side for image display, the reflection sheet 70 reflects the light to the front side.

The light guide plate 80 has the shape of a rectangular flat plate and is made of, for example, acrylic. The dimension of the rear face of the light guide plate 80 is substantially the same with the dimension of the reflection sheet 70. The long side of the reflection sheet 70 and the light guide plate 80 is somewhat shorter than the long side of the heat dissipation plate 50.

The reflection member 90 includes a sandwiched member 91 and a fitting member 92. The sandwiched member 91 is a member sandwiched between the heat dissipation plate 50 and the lower edge of the light guide plate 80, and has a shape extending in the long side direction of the heat dissipation plate 50. The fitting member 92 is a member which is fitted onto the lower ends of the heat dissipation plate 50, LED substrate 62, reflection sheet 70 and light guide plate 80 that are in the layered state, and which has a shape extending in the long side direction of the heat dissipation plate 50. The sandwiched member 91 and fitting member 92 have a length substantially the same as the length of the long side of the reflection sheet 70, the light guide plate 80 and the LED substrate 62, which is somewhat shorter than the long side of the heat dissipation plate 50. The sandwiched member 91 and the fitting member 92 are made of, for example, polycarbonate with a high reflectance.

On the rear face of the sandwiched member 91, a boss 911 protrudes therefrom, which is to be fitted into the through hole 55 formed at the upper shelf 53 of the heat dissipation plate 50. The upper part of the sandwiched member 91 is attached to the upper shelf 53 of the heat dissipation plate 50 while the boss 911 is aligned with the through hole 55 so as to be fitted therein.

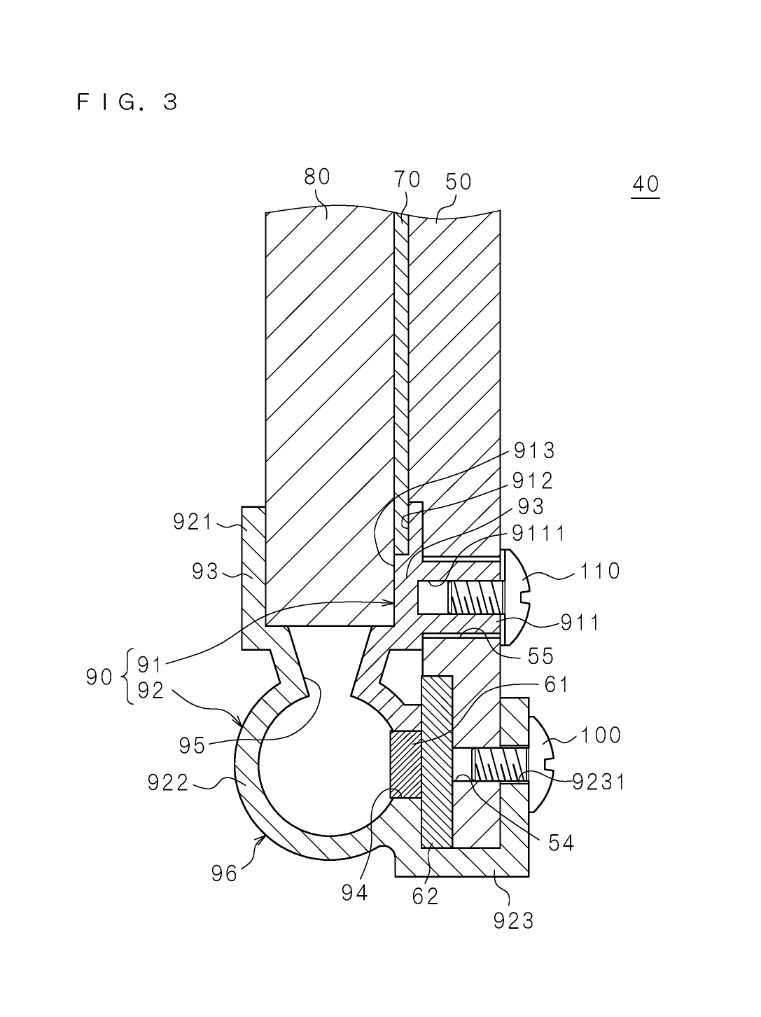

A step in the front-back direction is molded at the upper part on the front face of the sandwiched member 91, and an upper shelf 912 and a lower shelf 913 are formed with the step being the boundary thereof (see FIG. 3). Each of the upper shelf 912 and lower shelf 913 seen from the front side has a long and narrow rectangular shape extending in the long side direction of the heat dissipation plate 50. The height of the step between the upper shelf 912 and the lower shelf 913 substantially corresponds to the thickness of the reflection sheet 70.

FIG. 3 illustrates the internal structure of the lower end of the backlight 40. In FIG. 3, the left side represents the front side of the liquid crystal panel module 10 and the right side represents the rear side of the liquid crystal panel module 10. That is, in the liquid crystal panel module 10, the liquid crystal panel 20 is arranged to face the left side of the backlight 40 in FIG. 3. The illustration of FIG. 3 is drawn by combining a side section view passing through the substantial center of the screw 100 and screw hole 54, and a side section view passing through the substantial center of the through hole 55 and boss 911.

The LED 61 and LED substrate 62 are arranged on an extended plane formed by extending the rear face of the reflection sheet 70 or light guide plate 80 downward.

The reflection member 90 is arranged to face one side surface of the lower side of the light guide plate 80.

The fitting member 92 includes an upper fitting part 921, a partially-cylindrical part 922, a contact part 923 and sidewalls 924 (FIG. 2). The front side portions on both the left and right ends of the fitting member 92 are closed by the sidewalls 924, respectively. It is to be noted that the sidewalls 924 may also close the entire surface on both the left and right ends of the fitting member 92.

The upper fitting part 921 constitutes an upper part of the fitting member 92, and when the backlight 40 is assembled, forms a light shielding part 93 which is fitted onto the lower end of the light guide plate 80, together with the sidewalls 924 and the sandwiched member 91. The upper part of the light shielding part 93 forms a tubular shape extending in the left-right direction, and is fitted onto the lower end of the light guide plate 80. The light shielding part 93 has a function of shielding light so as to prevent the light output to the light guide plate 80 from leaking to the outside of the light guide plate 80.

The partially-cylindrical part 922 and the contact part 923 form the lower part of the fitting member 92. The partially-cylindrical part 922 has a partially cylindrical shape extending in the long side direction of the heat dissipation plate 50. The partially-cylindrical part 922 with both the left and right ends thereof closed by parts of the sidewalls 924 forms the reflection part 96 together with the lower end of the sandwiched member 91. The reflection part 96 has a hollow cylindrical shape with its inner diameter substantially the same with the thickness of the light guide plate 80. The reflection part 96 has functions of reflecting the light from the LED 61 at its inner surface and outputting the reflected light to the light guide plate 80. Here, the light output from the reflection part 96 is guided to one side surface of the light guide plate 80 by the light shielding part 93.

The contact part 923 is a portion of the fitting member 92 which is in contact with the lower end of the heat dissipation plate 50 and the LED substrate 62. The contact part 923 extends rearward from the rear face of the lower side of the partially-cylindrical part 922, rises upward from the lower end of the rear face of the heat dissipation plate 50, and has a J-shaped side section as a whole. With the lower end of the heat dissipation plate 50 and the LED substrate 62 held in a gap formed by the contact part 923; the fitting member 92, the heat dissipation plate 50 and the LED substrate 62 are temporarily fixed.

A through hole 9231 is formed at a position of the contact part 923 which is overlapped with the screw hole 54 of the heat dissipation plate 50. In the case where the backlight 40 is assembled, the fitting member 92 is fitted, from the lower side, onto the heat dissipation plate 50, reflection sheet 70 and light guide plate 80 that are layered from the rear side to the front side. Then, the screw 100 is inserted into the through hole 9231 of the contact part 923 to be screwed to the screw hole 54 of the heat dissipation plate 50. Moreover, the screw 110 is screwed into a screw hole 9111 of the boss 911 which is fitted into the through hole 55 of the heat dissipation plate 50.

At the lower part of the reflection part 96 formed by combining the sandwiched member 91 and the fitting member 92, a first opening 94 through which the LED 61 may be loosely fitted is formed at a position corresponding to the LED 61. The first opening 94 has a long and narrow rectangular shape extending along the extending direction of the reflection member 90. The lower end of the light shielding part 93 which is fitted onto the lower end of the light guide plate 80 is joined to the ceiling of the reflection part 96. At the ceiling portion of the reflection part 96 to which the light shielding part 93 is joined, a second opening 95 for the reflection part 96 to output the reflected light is formed. The second opening 95 has a long and narrow rectangular shape extending along the extending direction of the reflection member 90.

The inner surface of the reflection part 96 may be provided with metal plating which efficiently reflects light. The metal here is, for example, silver or gold. Alternatively, the inner surface of the reflection part 96 may be coated with a highly reflective coating material instead of metal plating.

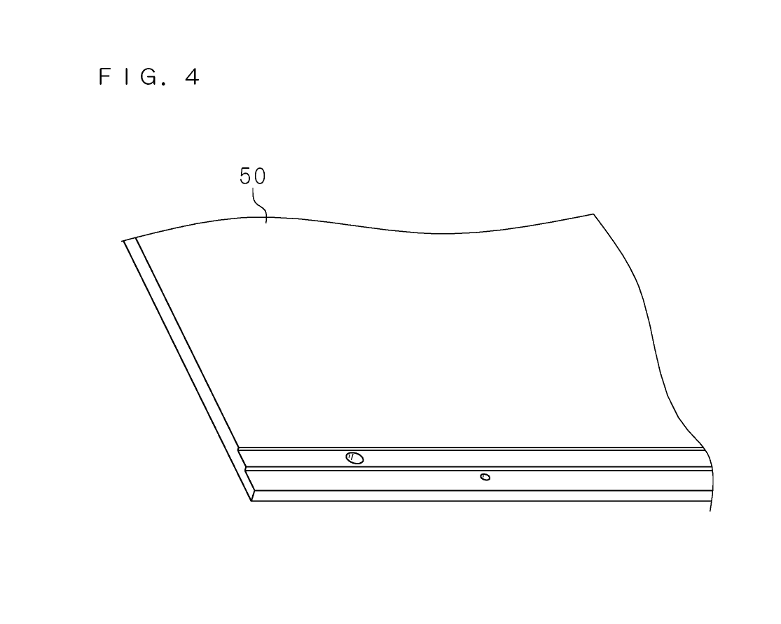

FIGS. 4 to 9 are explanatory views for illustrating the procedure of assembling the backlight 40.

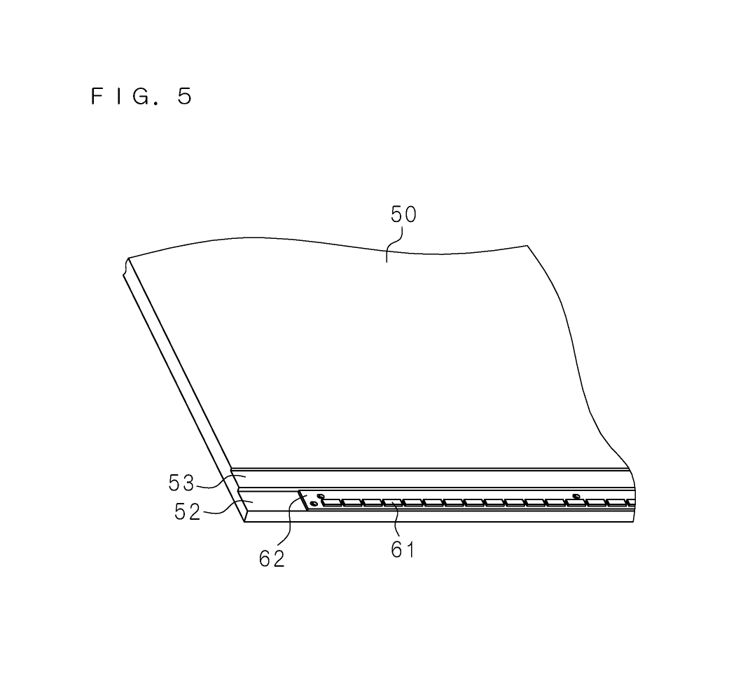

The procedure of assembling the backlight 40 is simply described. On a substantially horizontal table, the heat dissipation plate 50 is placed with its front surface facing upward (FIG. 4). The LED substrate 62 on which the LEDs 61 are mounted is adhered to the lower shelf 52 of the heat dissipation plate 50 with a double-sided tape (FIG. 5). Here, the LED substrate 62 is attached to the lower shelf 52 such that the center of LED substrate 62 is aligned with and substantially corresponds to the center of the lower shelf 52. It is to be noted that the LED substrate 62 may further be screwed to the lower shelf 52 of the heat dissipation plate 50.

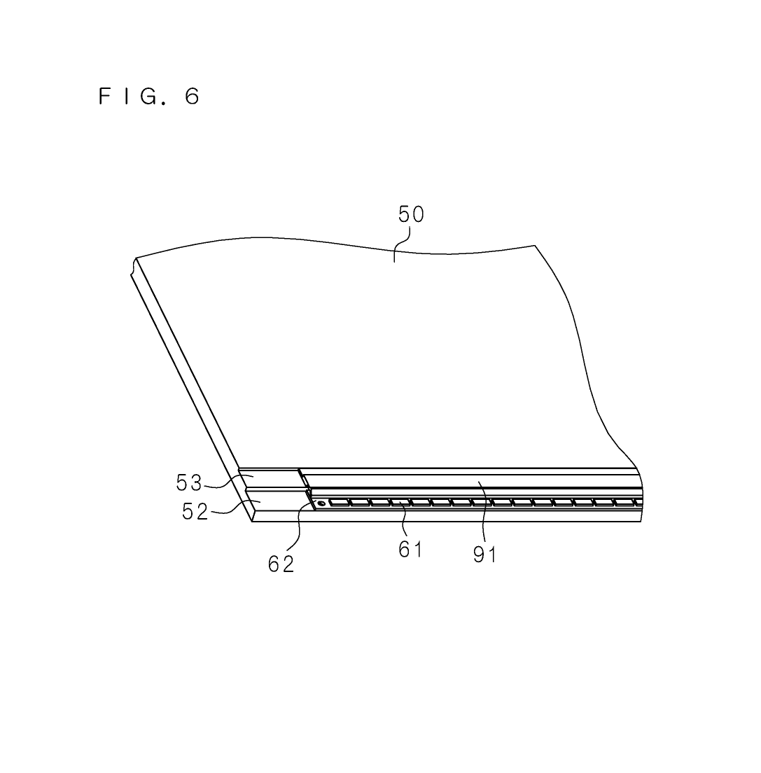

The sandwiched member 91 is mounted on the upper shelf 53 of the heat dissipation plate 50 and the LED substrate 62 (FIG. 6). Here, the boss 911 of the sandwiched member 91 is fitted into the through hole 55 of the heat dissipation plate 50. The rear face of the upper part of the sandwiched member 91 is placed on the upper shelf 53 while an end at the lower part of the sandwiched member 91 is placed on the LED substrate 62.

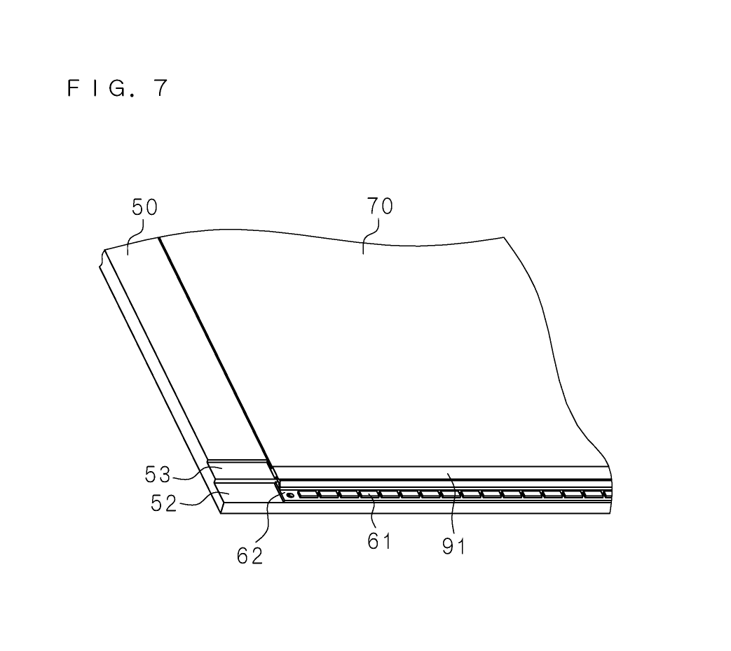

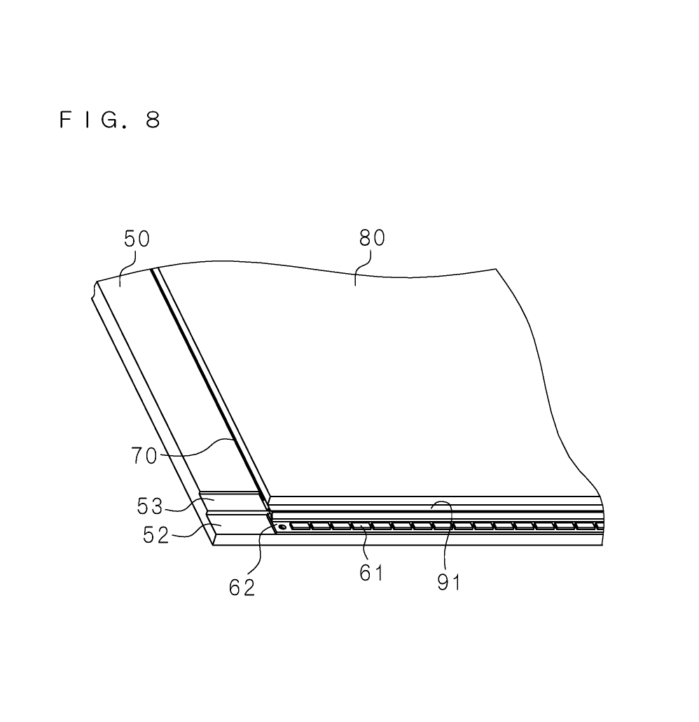

The reflection sheet 70 is mounted on the heat dissipation plate 50 while the lower end of the reflection sheet 70 touches the step portion at the lower side of the upper shelf 912 of the sandwiched member 91 (FIG. 3, FIG. 7). The light guide plate 80 is mounted on the reflection sheet 70 and the sandwiched member 91 while the lower end of the light guide plate 80 touches the step portion at the lower side of the lower shelf 913 of the sandwiched member 91 (FIG. 3, FIG. 8).

It is to be noted that the light guide plate 80 to which the reflection sheet 70 is adhered in advance may be mounted to the upper part of the sandwiched member 91 and to the reflection sheet 70.

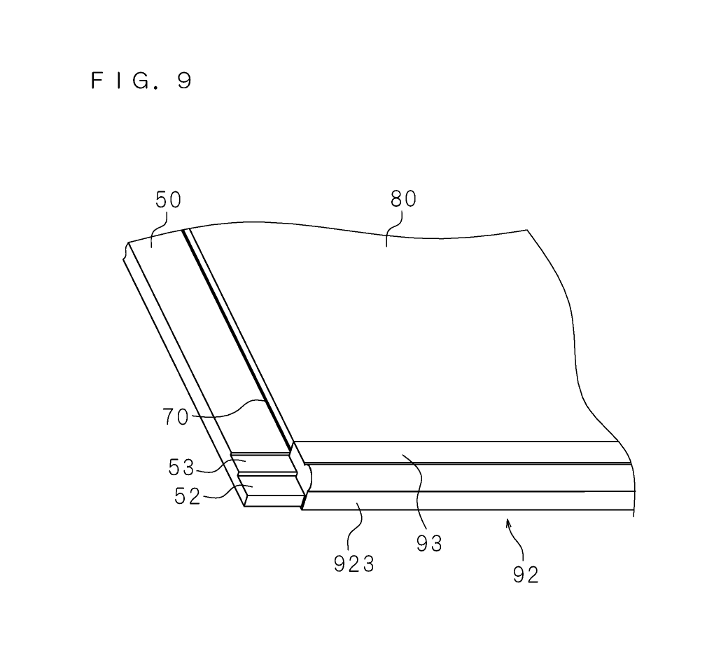

The fitting member 92 is put up from the lower side of the heat dissipation plate 50, the light guide plate 80 and so forth that are layered. Then, the light shielding part 93 constituted by the sandwiched member 91 and the fitting member 92 is fitted onto the lower end of the light guide plate 80 (FIG. 9). Moreover, the heat dissipation plate 50 and the LED substrate 62 are held in a recess formed by the contact part 923 and the sandwiched member 91. Here, the fitting member 92 is positioned with respect to the heat dissipation plate 50 such that the screw hole 54 of the lower shelf 52 of the heat dissipation plate 50 and the through hole 9231 of the fitting member 92 are overlapped with each other in the front-back direction (FIG. 3).

The screw 100 is screwed into the through hole 9231 and the screw hole 54. The screw 110 is screwed into the screw hole 9111 of the boss 911 of the sandwiched member 91. Thus, the components of the backlight 40 are fixed (FIG. 3).

Next, the operation of the backlight 40 is described. In the case where an “on” signal is transmitted from the source substrate to the LED 61, the LED 61 is turned on.

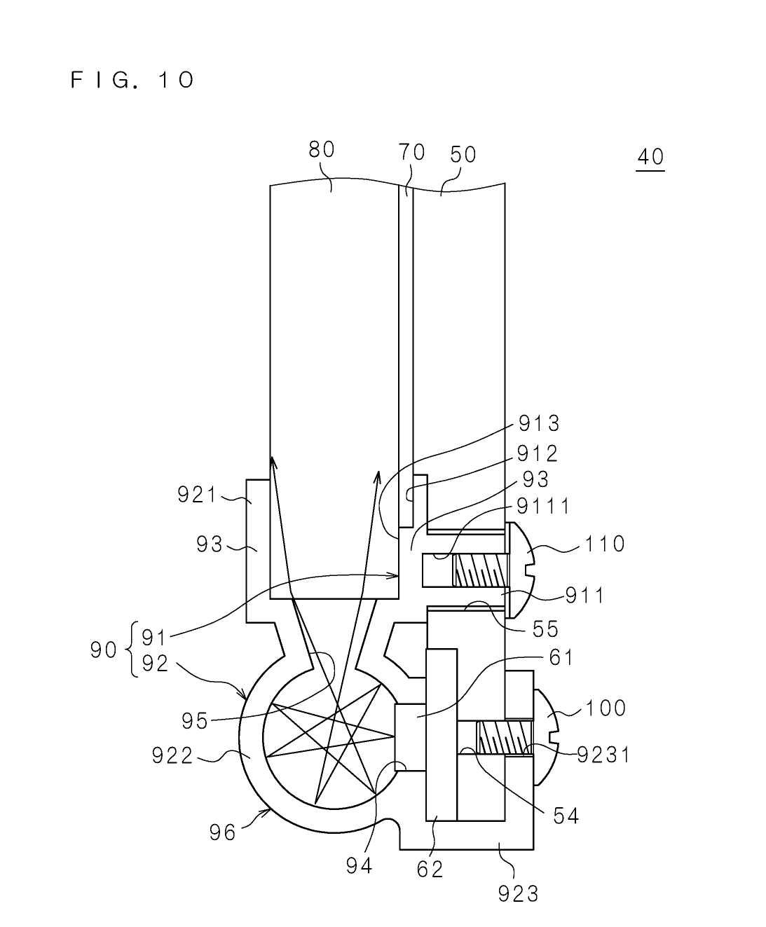

FIG. 10 is a view for illustrating a path of light output from the reflection member 90 to the light guide plate 80.

The light of the LED 61 enters from an opening surface of the first opening 94 into which the LED 61 is loosely fitted to the inside of the reflection part 96 at various angles. The entered light is irregularly reflected on the inner surface of the reflection part 96 and is uniformized. The irregularly-reflected light is output through the second opening 95 to one side surface of the light guide plate 80. Here, the space between the second opening 95 and one side surface of the light guide plate 80 is enclosed by the light shielding part 93 of the reflection member 90, the light output from the reflection part 96 is reflected at the inner surface of the light shielding part 93 and is directed to one side surface of the light guide plate 80. Thus, no light leaks to the outside of the light guide plate 80.

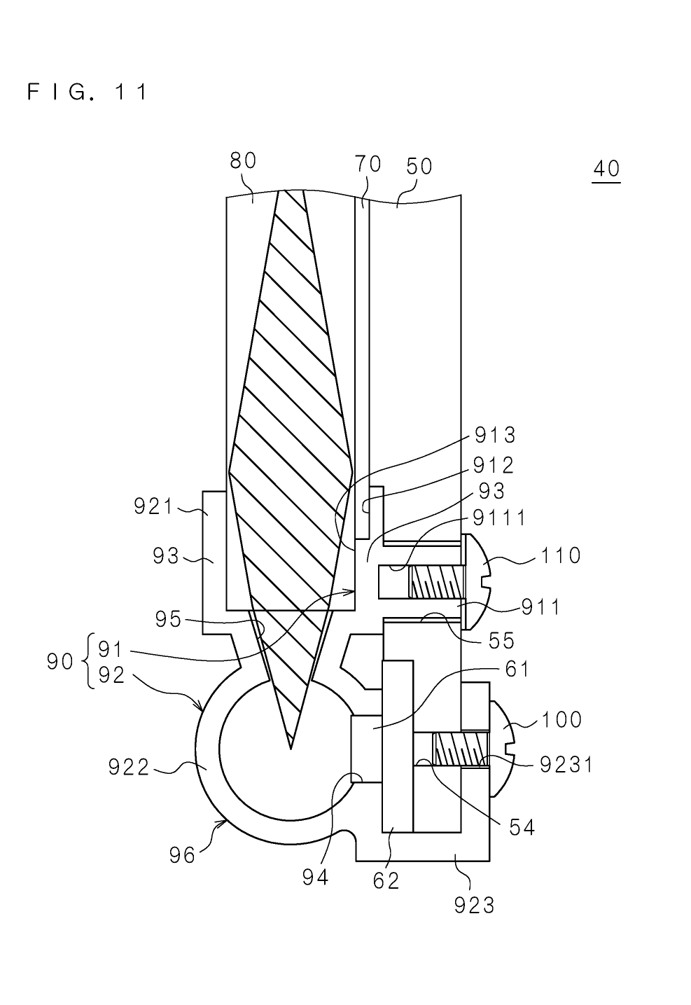

FIG. 11 is a view for illustrating a path of light flux output from the reflection member 90 to the light guide plate 80.

The reflection part 96 has the same side sectional shape as that of an integrating sphere. The light entering from the outside of the integrating sphere repeats irregular reflection on the inner surface of the integrating sphere and is integrated at the spatial center position. This allows the center of the integrating sphere to be filled with the light flux with a uniform intensity distribution proportional to the intensity of the light source without depending on the incident angle of light. Also at the reflection part 96, the light scattered at the inner surface is converged at the center axis so as to generate an integral of the light flux similar to that of the integral sphere. The uniform light flux converged at the center axis of the reflection part 96 passes from the second opening 95 through the light shielding part 93 and is output to one side surface of the light guide plate 80.

The light entered the light guide plate 80 is repeatedly reflected and diffused at the inner surface to spread out to a wide area of the light guide plate 80. The light directed to the other surface side of the light guide plate 80 is reflected to the opposite side by the reflection sheet 70. Accordingly, the light guide plate 80 outputs uniform light to the liquid crystal panel 20 from one surface which faces the liquid crystal panel 20.

In the description above, the side section of the outer surface of the reflection part 96 has a circular shape. The side section of the outer surface of the reflection part 96 may, however, be a triangular or quadrangular shape, for example.

In the description above, the LED substrate 62 on which the LEDs 61 are mounted and the light source module including the reflection member 90 are located below the light guide plate 80. It is, however, understood that the light source module may also be arranged above or beside the light guide plate 80. Moreover, two, three or four light source modules may also be arranged to face the side surfaces of the light guide plate 80.

According to the backlight 40, a loss of light from the LEDs 61 may be reduced.

The output angle of the light from the conventional LEDs that are arranged to face one side surface of a light guide plate corresponds to 0 to 180 degrees. Thus, some of the light from the LEDs leaks to the outside of the light guide plate due to a gap formed between the LEDs and the light guide plate. The light shielding part 93 of the reflection member 90, however, guides all the light flux output from the center axis of the reflection part 96 to the light guide plate 80, and therefore a loss of light from the LEDs 61 may significantly be reduced with the backlight 40.

The light output from the LEDs 61 to the reflection part 96 is uniformized due to irregular reflection at the inner wall of the reflection part 96 without depending on its output angle, is converged at the center part of the reflection part 96 and is thereafter output to the light guide plate 80. This allows the backlight 40 to uniformize the intensity of planar light output from one surface of the light guide plate 80.

In the case where the liquid crystal panel 20 is arranged to face one surface of the light guide plate 80, the backlight 40 may enhance the luminance of the screen 21 on the liquid crystal panel 20 and suppress unevenness in luminance.

With the backlight 40, since the LED substrate 62 is joined to the heat dissipation plate 50, the heat generated from the LEDs 61 may efficiently be transferred to the heat dissipation plate 50. This can prevent degrading of the LEDs 61 due to temperature rise and can also prevent the light guide plate 80 from pressing the other members due to thermal expansion. Furthermore, by increasing the thickness of the light guide plate 80, the heat dissipation efficiency may further be enhanced.

The backlight 40 may be used for another purpose including indoor or outdoor electric light.

### Embodiment 2

Embodiment 2 relates to a form in which a reflection surface curved inward is formed on the inner surface of the reflection part 96 that faces the LEDs 61 or the first opening 94.

In Embodiment 2, the components similar to those in Embodiment 1 will be denoted by the same reference numbers and will not be described in detail.

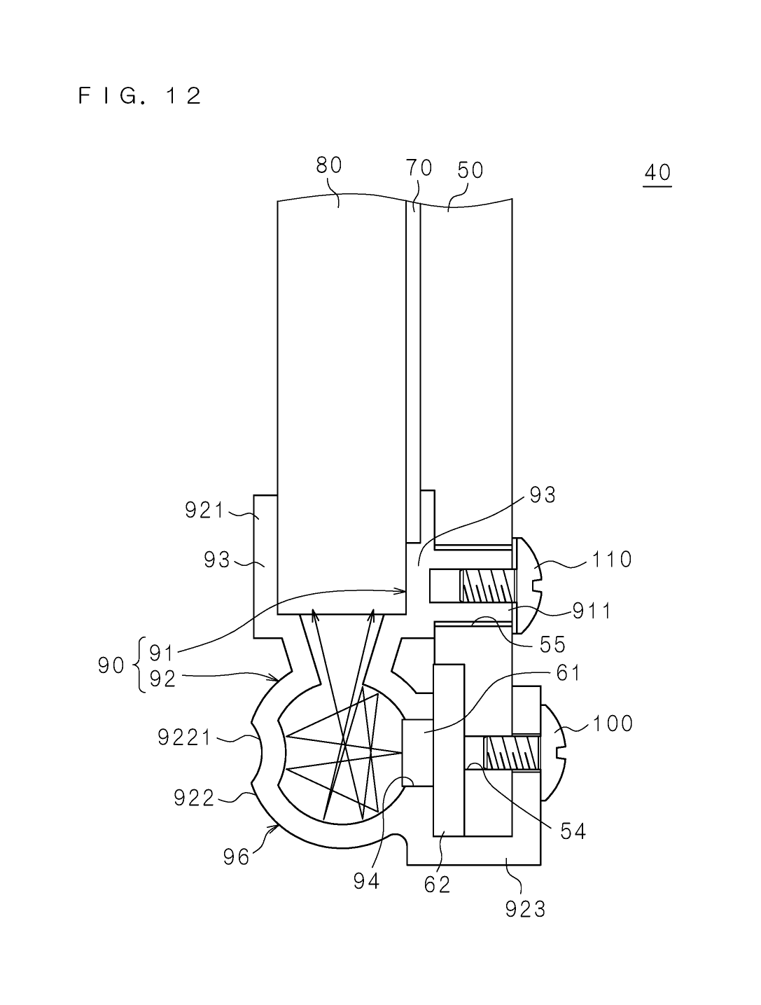

FIG. 12 is a view for illustrating the internal structure of the lower end of the backlight 40. In FIG. 12, the left side represents the front side of the liquid crystal panel module 10 whereas the right side represents the rear side of the liquid crystal panel module 10. FIG. 12 is drawn by combining a side section passing through the substantial center of the screw 100 and screw hole 54 with a side section view passing through the substantial center of the screw 110, through hole 55 and boss 911.

At the sidewall of the reflection part 96 that faces the LEDs 61, a recess 9221 is formed. On the cross section in FIG. 12, the recess 9221 has a circular arc shape curved inward (to the center axis side of the partially-cylindrical part 922) at the same curvature as that of the other sidewall portion. The recess 9221 extends in the direction of the center axis of the partially-cylindrical part 922 to correspond to the contour of the partially-cylindrical part 922.

Next, the operation of the backlight 40 is described.

In FIG. 10, the light output from the LEDs 61 at an angle range of, for example, around eight degrees to the direction toward the left side from the LEDs 61 is reflected at the inner surface of the sidewall of the reflection part 96 which faces the LEDs 61 and is returned to the LEDs 61. In the case of the reflection part 96 in FIG. 12, however, most of the light output from the LEDs 61 in the angle range of, for example, around eight degrees is reflected to the outside of the LEDs 61 by the recess 9221. Therefore, little light is returned to the LEDs 61 after being output from the LEDs 61.

In the description above, the recess 9221 is formed by deforming the sidewall of the reflection part 96. However, no deformation may be made on the sidewall of the reflection part 96. For example, a reflection member having the same shape as that of the recess 9221 may be provided on the inner surface of the sidewall of the reflection part 96 that corresponds to the position of the recess 9221.

According to the backlight 40, lowering in the luminance of the LEDs 61 may be suppressed.

Among the light returned to the LEDs 61, when passing through the inside of the resin of the LED chip containing illuminants (red, green and blue), the light of a wavelength which cannot pass through the illuminants is changed to heat, causing coloring of the illuminants. This facilitates degrading of the LEDs 61 and may result in lowering in the luminance of the LEDs 61. However, the recess 9221 of the reflection part 96 reduces the amount of light returning to the LEDs 61, which can prevent the coloring of the illuminants in the LED chip and can suppress lowering in the luminance of the LEDs 61. Therefore, the recess 9221 produces an effect of suppressing lowering in luminance on the screen 21 of the liquid crystal panel 20.

### Embodiment 3

Embodiment 3 relates to a form in which multiple rows of LEDs 61 are arranged around the reflection part 96.

In Embodiment 3, components similar to those in Embodiments 1 and 2 will be denoted by the same reference numbers and will not be described in detail.

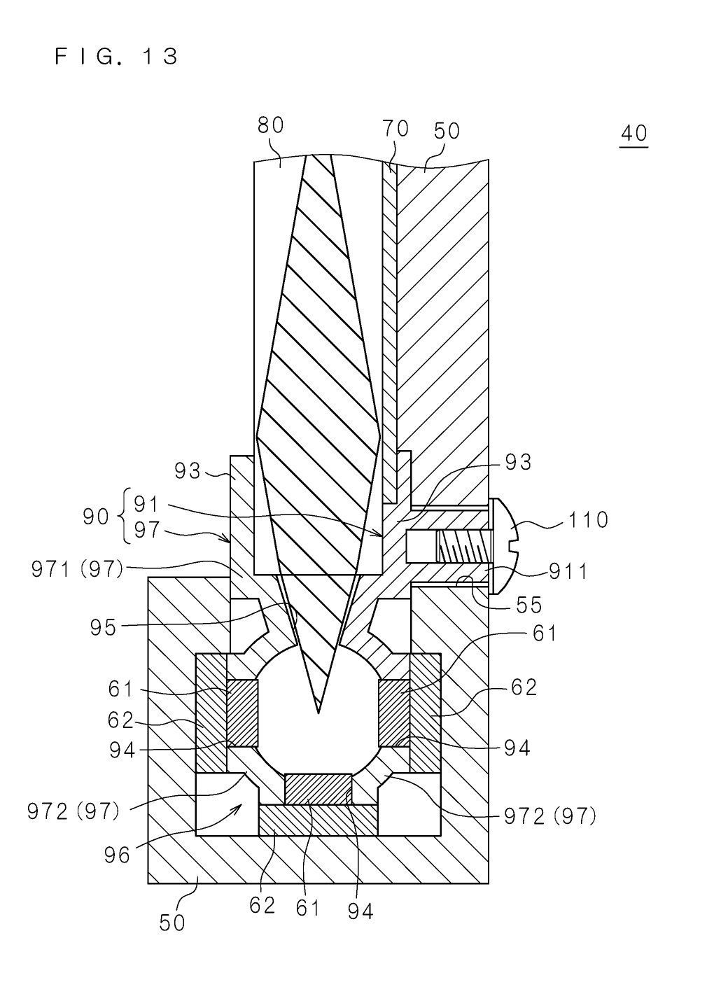

FIG. 13 is a section view illustrating the internal structure of the lower end of the backlight 40. In FIG. 13, the left side represents the front side of the liquid crystal panel module 10 whereas the right side represents the rear side of the liquid crystal panel module 10. FIG. 13 is a side section view obtained by cutting the backlight 40 across the cutting surface passing through the substantial center of the screw 110, through hole 55 and boss 911.

The reflection member 90 does not include a fitting member 92 but includes a sandwiched member 91 and a multi-row reflection member 97. The sandwiched member 91 is the same as the sandwiched member 91 according to Embodiment 1, and is a member sandwiched between the heat dissipation plate 50 and an edge of the lower part of the light guide plate 80.

The multi-row reflection members 97 are three members, each of which has a shape extending in the long side direction of the heat dissipation plate 50 similarly to the fitting member 92, and is made of polycarbonate having high reflectance. The length of the multi-row reflection member 97 is substantially the same as the length of the LED substrate 62, which is somewhat shorter than the long side of the heat dissipation plate 50. A part or the whole of each of the left and right ends in the longitudinal direction of the multi-row reflection member 97 is closed by a sidewall (not illustrated) similar to the sidewall 924 of the fitting member 92.

The multi-row reflection member 97 includes an upper sandwich part 971 and the lower partially-cylindrical part 972. The upper part of the upper sandwich part 971 forms, together with the sidewalls of the sandwiched member 91 and the multi-row reflection member 97, a light shielding part 93 similar to that in Embodiment 1. The upper part of the light shielding part 93 is fitted, from the outside, onto the lower end of the light guide plate 80 which receives light.

The lower end of the upper sandwich part 971 forms the upper side of a partial cylinder together with the lower end of the sandwiched member 91.

The lower partially-cylindrical parts 972 are two members forming the lower part of the multi-row reflection member 97, which form the lower side of the partial cylinder. In the case where the backlight 40 is assembled, the lower end of the upper sandwich part 971, the lower end of the sandwiched member 91, the lower partially-cylindrical parts 972 and the sidewalls of the multi-row reflection member 97 form, as a whole, a hollow cylindrical reflection part 96, the diameter thereof being substantially the same as the thickness of the light guide plate 80.

In FIG. 13, three LED substrates 62 on which multiple LEDs 61 arranged substantially parallel to the center axis of the reflection part 96 are located, respectively, at the left side, right side and lower side of the reflection part 96. Each LED substrate 62 is arranged with a plane on which the LEDs 61 are mounted facing the reflection part 96.

At the sidewalls of the reflection part 96 respectively facing the three LED substrates 62, the first opening 94 is provided, one for each, through which the LEDs 61 aligned on each LED substrate 62 may loosely be fitted. At the ceiling portion of the reflection part 96 to which the light shielding part 93 is joined, one second opening 95 is formed. The shape, size and function of each of the first opening 94 and the second opening 95 are the same as those of the first opening 94 and the second opening 95 according to Embodiment 1. That is, the first opening 94 is an opening for the light from the LEDs 61 to enter the reflection part 96. On the other hand, the second opening 95 is an opening for outputting the light reflected at the inner surface of the reflection part 96 to one side surface of the light guide plate 80.

In FIG. 13, the lower part of the heat dissipation plate 50 is bent in a J- or U-shape from the rear side to the front side so as to surround the reflection part 96. Each of the bent corners forms a substantially right angle. In FIG. 13, the LED substrates 62 are adhered, one for each, to the left side inner surface, right side inner surface and lower side inner surface of the bent heat dissipation plate 50 with double-sided tapes.

Next, the operation of the backlight 40 is described. The light from the LEDs 61 enter the inside of the reflection part 96 from the three first openings 94 in which the LEDs 61 are loosely fitted at various output angles. The entered light is irregularly reflected at the inner surface of the reflection part 96 and is uniformized. The light irregularly reflected at the inner surface is converged to the center axis of the reflection part 96, passes through the second opening 95 as integrated light and is output to one side surface of the light guide plate 80.

Since the space between the second opening 95 and one side surface of the light guide plate 80 is enclosed by the light shielding part 93, the light output from the reflection part 96 is reflected at the inner surface of the light shielding part 93 and is directed to one side surface of the light guide plate 80. Thus, no light leaks to the outside of the light guide plate 80.

The light entering the light guide plate 80 is repeatedly reflected and diffused at the inner surface to spread to a wide area of the light guide plate 80. Moreover, the light directed toward the opposite side of one surface of the light guide plate 80 which faces the liquid crystal panel 20 is reflected to one surface side by the reflection sheet 70. Accordingly, the light guide plate 80 outputs uniform light to the liquid crystal panel 20 from one surface which faces the liquid crystal panel 20.

In the description above, three LED substrates 62 on which multiple LEDs 61 are mounted are arranged around the reflection part 96. It is, however, understood that two LED substrates 62 or four or more LED substrates 62 may be arranged around the reflection part 96.

According to the backlight 40, since multiple LED substrates 62 on which LEDs 61 are mounted are provided, a light flux with larger emission energy can be output to the light guide plate 80. This can therefore enhance the luminance on the screen 21 of the liquid crystal panel 20.

Though a larger amount of heat is generated from the LEDs 61 by the amount corresponding to the increased number of LED substrates 62, all LED substrates 62 are joined to the heat dissipation plate 50, making the heat efficiently discharged to the outside of the liquid crystal panel module 10.

The embodiments disclosed herein are to be construed as illustrative and not restrictive in all aspects. The scope of the invention is defined by the appended claims rather than by the description preceding them, and all changes that fall within metes and bounds of the claims, or equivalence of such metes and bounds thereof are therefore intended to be embraced by the claims.

The components (technical features) disclosed in the embodiments can be combined with one another, while the combination thereof can form a new technical feature.

A lighting device 40 reflecting light from a light source 61, making reflected light enter one side surface of a light guide plate 80, and outputting entered light from one surface of the light guide plate 80 includes: a reflection part 96 reflecting light at an inner surface thereof and having, at an inside thereof, a hollow part extending in a long side direction of one side surface of the light guide plate 80, the cross section of the hollow part perpendicular to the long side direction of the one side surface having a circular shape; and multiple light sources 61 arranged in the long side direction of the one side surface along an outer side surface of the reflection part 96.

The reflection part 96 includes: a first opening 94 through which light enters inside from the multiple light sources 61; and a second opening 95 for outputting light entered from the first opening 94 and reflected at an inner surface to the one side surface of the light guide plate 80. The lighting device further includes a light shielding part 93 shielding light output from the second opening 95 and leaking to the outside of the one side surface of the light guide plate 80.

According to the lighting device 40, a loss of light from the light source 61 may be reduced.

The output angle of light from the conventional light source arranged to face one side surface of a light guide plate corresponds to 0 to 180 degrees. Thus, some of the light from the light source leaks to the outside of the light guide plate due to a gap formed between the light source and the light guide plate. The light shielding part 93, however, guides all the light flux output from the center axis of the reflection part 96 to the light guide plate 80, and therefore a loss of light from the light sources 61 may significantly be reduced with the lighting device 40.

The light output from the light sources 61 to the reflection part 96 is uniformized due to irregular reflection at the inner wall of the reflection part 96 without depending on its output angle, is converged at the center part of the reflection part 96 and is thereafter output to the light guide plate 80. This allows the lighting device 40 to emit planar light with uniform intensity.

In the lighting device 40, a curved surface which is curved inward is formed at an inner surface portion of the reflection part 96 facing the first opening 94.

According to the lighting device 40, lowering in luminance of the light source 61 may be suppressed.

Among the light returned to the light source 61, when passing through the inside of the resin of the light source chip containing illuminants (red, green and blue), the light of a wavelength which cannot pass through the illuminants is changed to heat, causing coloring of the illuminants. This facilitates degrading of the light source 61 and may result in lowering in the luminance of the light source 61. However, the curved surface which is curved toward the inside of the reflection part 96 reduces the amount of light returning to the light source 61, which can prevent the coloring of the illuminants in the light source chip and can suppress lowering in the luminance of the light sources 61.

In the lighting device 40, multiple light sources 61 are arranged in multiple rows along an outer side surface of the reflection part 96, and the reflection part 96 includes a multiple number of the first openings 94 for making light enter from each row of the light sources 61.

According to the lighting device 40, multiple light sources 61 are aligned in multiple rows, and the light from each row of the light sources 61 enters from the respective first openings 94 to the reflection part 96, so that light flux having larger emission energy may be output to the light guide plate 80.

The lighting device 40 includes: a substrate 62 on which the light source 61 mounted on one surface thereof; a reflection sheet 70 with one surface covering another surface of the light guide plate 80; and a heat dissipation plate 50 being in contact with another surface of the reflection sheet 70 and being wider than the reflection sheet 70. Another surface of the substrate 62 is in contact with the heat dissipation plate 50.

According to the lighting device 40, since the substrate 62 is joined to the heat dissipation plate 50, the heat generated from the light source 61 may efficiently be transferred to the heat dissipation plate 50. This can prevent degrading of the light source 61 due to temperature rise and can also prevent the light guide plate 80 from pressing the other members due to thermal expansion.

A liquid crystal display apparatus 210 includes: the lighting device 40 according to the description above; and a liquid crystal panel 20 displaying an image using light output from one surface of the light guide plate 80 in the lighting device 40.

According to the liquid crystal display apparatus 210, the luminance on the screen 21 of the liquid crystal panel 20 may be enhanced by the lighting device 40 reducing a loss of light from the light source 61.

In the lighting device 40, metal plating is applied to the inner surface of the reflection part 96.

The metal plating applied to the inner surface of the reflection part 96 may enhance the reflectance of light. This allows the reflection part 96 to efficiently reflect light even if its material has a low reflectance.

1-5. (canceled)

6. A lighting device, comprising:
a reflection part with a circular cross section which is perpendicular to a long side direction of one first side surface of a light guide plate outputting light entered the one side surface from one surface, having a hollow part extending in the long side direction of the one side surface, and further including a first opening for making light enter an inside of the hollow part, a second opening for outputting light entered from the first opening and reflected at an inner surface to the one side surface of the light guide plate, and a light shielding part shielding light output from the second opening and leaking to an outside of the one side surface of the light guide plate; and
a plurality of light sources arranged in the long side direction of the one side surface along an outer side surface of the reflection part and making emitted light enter from the first opening.

7. The lighting device according to claim 6, wherein a curved surface curved inward is formed at an inner surface portion of the reflection part facing the first opening.

8. The lighting device according to claim 6, wherein
the plurality of light sources are arranged in a plurality of rows along an outer side surface of the reflection part, and
the reflection part includes a plurality of the first openings for making light enter from each row of the light source.

9. The lighting device according to claim 6, comprising:
a substrate on which the light source is mounted on one surface;
a reflection sheet with one surface covering another surface of the light guide plate; and
a heat dissipation plate being in contact with another surface of the reflection sheet and being wider than the reflection sheet,
wherein another surface of the substrate is in contact with the heat dissipation plate.

10. A liquid crystal display apparatus, comprising:
the lighting device according to claim 6; and
a liquid crystal panel displaying an image using light output from one surface of the light guide plate in the lighting device.
